(19) United States
(12) Patent Application Publication
(10) Pub. No.: US 2013/0173204 A1
(43) Pub. Date: Jul. 4, 2013

(54) SYSTEM AND METHOD FOR MEASURING TRACE WIDTH OF PCB

(71) Applicants: GUANG-FENG OU, Shenzhen City (CN); YONG-ZHAO HUANG, Shenzhen City (CN)

(72) Inventors: GUANG-FENG OU, Shenzhen City (CN); YONG-ZHAO HUANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/600,253

(22) Filed: Aug. 31, 2012

(30) Foreign Application Priority Data
Dec. 29, 2011 (CN) 201110450551.4

(51) Int. Cl. G06F 19/00

(52) U.S. Cl. 702/120

(57) ABSTRACT

A measuring system executable by a computer for measuring a PCB is provided. A layout information obtaining module obtains layout information of the PCB. A parameter setting interface display module display a parameter setting interface on a display screen. A measuring parameter setting module determines customized parameters in response to an operator's operation on a parameter setting button provided by the parameter setting interface. A measurement analyzing module obtains the customized parameters and measures the widths of the selected traces, determines whether the measured widths matches with the width parameters. A measuring result obtaining module obtains a measuring result provided by the measurement analyzing module, and identifying the traces of which the measured widths do not match with the width parameters associated therewith. A related method is also provided.

### BACKGROUND

1. Technical Field

The present disclosure relates to PCB layout technology and, particularly, to a system and method for measuring a trace width of a trace of a PCB.

2. Description of the Related Art

PCB layout is commonly measured to assure trace widths of the PCB to meet layout requirements, which reduces an interference of electronic components. In existing measuring technology, a measuring system takes pictures of the PCB layout and determines trace widths of the PCB layout by human eyes, which results in low accuracy and efficiency.

Therefore, there is room for improvement within the art.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of a measuring system, according to an exemplary embodiment.

FIG. 2 is a block diagram of the measuring system of FIG. 1.

FIG. 3 is a schematic view of a parameter setting interface provided by the measuring system of FIG. 1, in accordance with an exemplary embodiment.

FIG. 4 is a flowchart of a method of measuring trace width of a PCB, in accordance with an exemplary embodiment.

### DETAILED DESCRIPTION

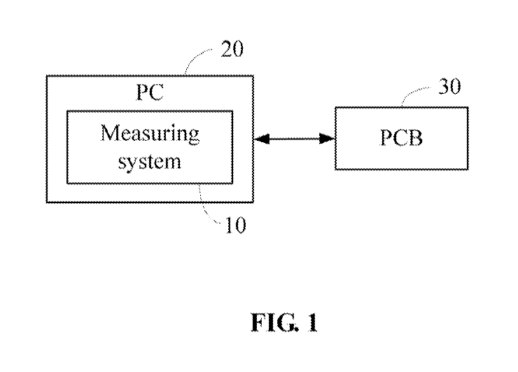

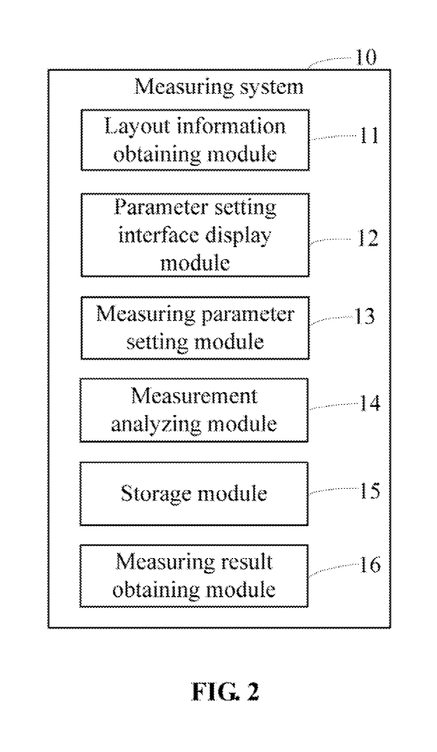

Referring to FIGS. 1 and 2, a PC 20 of one embodiment is shown. The PC 20 includes a measuring system 10 for measuring the PCB 30. The measuring system 10 includes a layout information obtaining module 11, a parameter setting interface display module 12, a measuring parameter setting module 13, a measurement analyzing module 14, a storage module 15, and a measuring result obtaining module 16. The layout information obtaining module 11 is configured for obtaining layout information of the PCB 30. The storage module 15 is configured for storing the layout information obtained by the layout information obtaining module 11. The layout information includes trace names, trace widths and trace positions of traces of the layout pattern of the PCB 30.

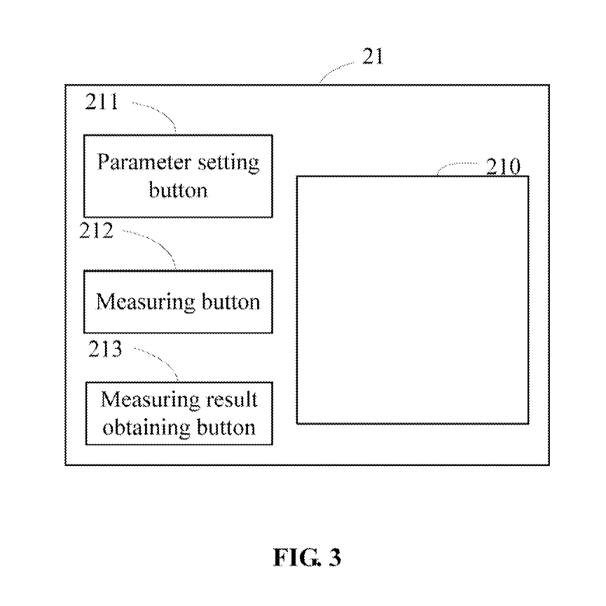

Referring to FIG. 3, the parameter setting interface display module 12 is configured for obtaining the layout information from the storage module 15, and displaying a parameter setting interface 21 on the PC 20. The parameter setting interface 21 includes a display window 210, a parameter setting button 211, a measuring button 212, and a measuring result obtaining button 213. The display window 210 is configured for displaying the layout information obtained from the storage module 15 by the parameter setting interface display module 12. The parameter setting interface 21 display module further displays a measuring setting interface on the PC 20, for allowing the user to input the customized width parameters of the selected traces.

The measuring parameter setting module 13 is configured for determining customized parameters of the obtained layout information, and generating a setting command in response to a user's operation on the parameter setting button 211. The parameter setting interface display module 12 is further configured for displaying a customized parameters setting interface on the PC 20 in response to the setting command generated by the measuring parameter setting module 13. The customized parameters setting interface is configured for displaying the property of the obtained layout information determined by the measuring parameter setting module 13. The measuring parameter setting module 13 is further configured for setting a customized parameters in response to the user's operation on the customized parameters interface, and the storage module 15 stores the customized parameters set by the measuring parameter setting module 13. The customized parameters set by the measuring parameter setting module 13 includes the names of the traces to be measured selected by the operator and width parameters of the selected traces.

The measurement analyzing module 14 is configured for generating a measuring command in response to the user's operation on the measuring button 212, obtaining the layout information and the customized parameters from in the storage module 15, measuring the widths of the selected traces, and further determining whether the measured widths matches with the width parameters associated therewith. The storage module 15 stores the measuring result determined by the measurement analyzing module 14.

The measuring result obtaining module 16 is configured for obtaining the measuring result from the storage module 15 in response to the user's operation on the measuring result obtaining button 213. The parameter setting interface display module 12 displays a measuring result interface on the PC 20 for displaying the measuring result. The measuring result obtaining module 16 further identifies the traces of which the measured widths do not match with the width parameters associated therewith determined by the measurement analyzing module 14. In the embodiment, the customized width parameter include a width threshold, the measuring result obtaining module 16 identifies the traces whose widths are less than the corresponding width thresholds.

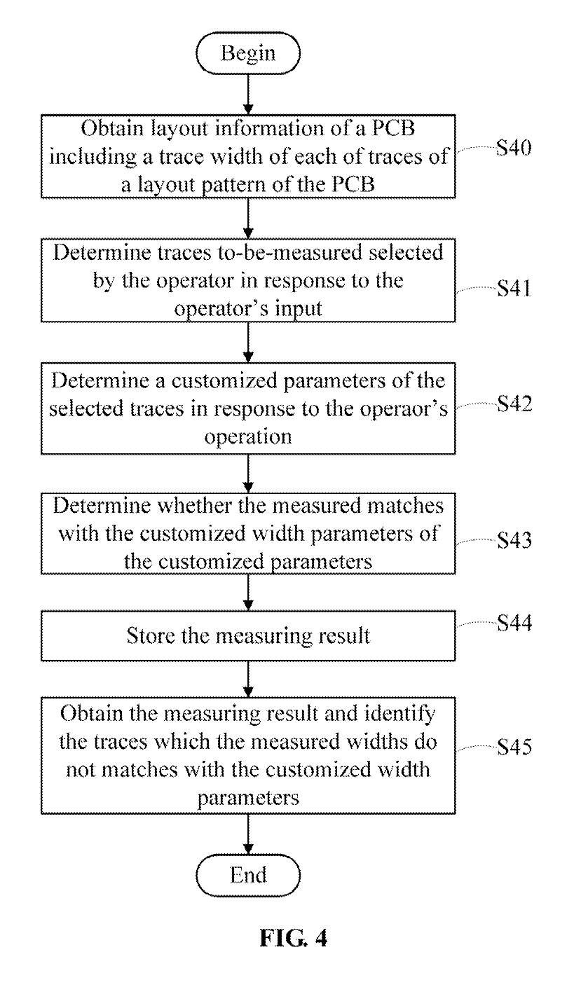

FIG. 4 is a flowchart illustrating an exemplary method of measuring trace width of the PCB.

In step S40, the layout information obtaining module 11 obtains the layout information of the PCB 30, and the storage module 15 stores the obtained layout information. The layout information includes a trace width of each of traces of a layout pattern of the PCB, names, and positions of a number of traces arranged on the PCB 30.

In step S41, the parameter setting interface display module 12 obtains the layout information from the storage module 12, and displays the parameter setting interface 21 on the PC 20 for displaying the layout information. The measuring parameter setting module 13 determines traces to-be-measured selected by the use in response to the user's input.

In step S42, the measuring parameter setting module 13 controls the parameter setting interface display module 12 to display the customized parameters setting interface on the PC 20, determines the customized parameters in response to the user's operation on the customized parameters setting interface, and stores the set customized parameters in the storage module 15. The customized parameters includes the names of the traces to be measured and the widths of the traces set by the user.

In step S43, the measurement analyzing module 14 obtains the layout information and the customized parameters stored in the storage module 15, measures the widths of the traces whose names correspond to the names of the customized parameters, and further determines whether the measured matches with the customized width parameters of the customized parameters correspondingly.

In step S44, the storage module 15 stores the measuring result determined by the measurement analyzing module 14.

In step S45, the measuring result obtaining module 16 obtains the measuring result from the storage module 15, and identifies the traces which the measured widths do not matches with the customized width parameters determined by the measurement analyzing module 14.

The parameter setting interface display module 12 displays a measuring result interface on the PC 20 for displaying the measuring result. In the embodiment, the customized width parameter include a width threshold, the measuring result obtaining module 16 identifies the traces whose widths are smaller than the width of the customized parameters determined by the measurement analyzing module 14.

It is understood that the present disclosure may be embodied in other forms without departing from the spirit thereof. The present examples and embodiments are to be considered in all respects as illustrative and not restrictive, and the disclosure is not to be limited to the details given herein.

What is claimed is:

1. A measuring system, wherein the measuring system is employed in a computer and executable by the computer, and configured for measuring a PCB, the measuring system comprising:
a layout information obtaining module configured for obtaining layout information of the PCB, wherein the layout information comprises trace names, trace widths and trace positions of traces of a layout pattern of the PCB;
a storage module configured for storing the layout information obtained by the layout information obtaining module;
a parameter setting interface display module configured for displaying a parameter setting interface on a display screen, wherein the parameter setting interface displays a parameter setting button, a measuring button, and a measuring result obtaining button;
a measuring parameter setting module configured for determining customized parameters in response to an operator's operation on the parameter setting button, and storing the customized parameters in the storage module, wherein the customized parameters comprise the names of the traces to be measured selected by the operator and width parameters of the selected traces;
a measurement analyzing module configured for obtaining the layout information and the customized parameters from the storage module in response to the operator's operation on the measuring button, measuring the widths of the selected traces, determining whether the measured widths matches with the width parameters associated therewith, and further storing a measuring result determined in the storage module; and
a measuring result obtaining module configured for obtaining the measuring result from the storage module in response to the operator's operation on the measuring result obtaining button, and identifying the traces of which the measured widths do not match with the width parameters associated therewith.

2. The measuring system as recited in claim 1, wherein the customized width parameter include a width threshold, the measuring result obtaining module identifies the traces whose widths are less than the corresponding width thresholds.

3. The measuring system as recited in claim 1, wherein the parameter setting interface display module is further configured for displaying a measuring setting interface on the display screen, for allowing the operator to input the customized width parameters of the selected traces.

4. A method for measuring a trace width of a PCB, the method applied in a computer, and the method comprising:
connecting a PCB to the computer;
obtaining layout information of the PCB and storing the obtained layout information, wherein the layout information comprises a trace width of each of traces of a layout pattern of the PCB;
determining traces to-be-measured selected by an operator in response to the operator's input;
determining a customized width parameter of each of the selected traces in response to the operator' input;
measuring the width of each of the selected traces; and
determining whether the measured width of each of the selected traces matches with the customized width parameters associated therewith; and
identifying and displaying traces of which the measured widths do not matches with the customized width parameters associated therewith to the operator.

5. The method as recited in claim 4, wherein the customized width parameter include a width threshold, the traces with the measured widths thereof less than the width thresholds associated therewith are identified and displayed.
